(19) United States
(12) Patent Application Publication
(10) Pub. No.: US 2003/0050116 A1
(43) Pub. Date: Mar. 13, 2003

(54) Picture video signal converting/processing circuit for GBA (gameboy advance) or GBC (gameboy color)

(76) Inventor: William Chen, Taipei (TW)

Correspondence Address: BACON & THOMAS, PLLC, 625 SLATERS LANE, FOURTH FLOOR, ALEXANDRIA, VA, 22314

(21) Appl. No.: 09/948,559

(22) Filed: Sep. 10, 2001

(51) Int. Cl. A63F 13/00

(52) U.S. Cl. 463/30

(57) ABSTRACT

Picture video signal converting/processing circuit for GBA (gameboy advance) or GBC (gameboy color), which is with the game main frame by means of a game cartridge adapter or disassembling the lower cover of the game main frame. The circuit is able to take the video signal input produced by the GBA or GBC main frame or cartridge, including pixel signal, horizontal synchronous signal (H-SYNC), vertical synchronous signal (V-SYNC), dot clock signal and audio signal. Through the command decoding of the main controlling circuit (ASIC) and in cooperation with the digital/analog signal converter (DAC), the input video signals are converted into RGB signals which are converted by the RGB encoder into video signals acceptable by all kinds of televisions. Therefore, the picture of the LCD panel of the GBA or GBC main frame can be converted and shown on the screens of various kinds of televisions. The video signals converted by the RGB encoder can be also processed by video graphic array interface card to convert and input the picture of the LCD panel of the GBA or GBC to various specifications of computer monitors.

### BACKGROUND OF THE INVENTION

The present invention is related to a technique for converting picture video signals, and more particularly to a picture video signal converting/processing circuit for GBA (gameboy advance) or GBC (gameboy color). The circuit is able to take the necessary signal from the LCD panel of the GBA or GBC main frame and decode and convert the video signals into combined video signals acceptable and shown by all kinds of televisions and computer monitors. The big screen provides more brilliant colorful picture and achieve live entertaining effect. Also, the player's eyes are protected from feeling painful or getting hurt.

The existing handheld game such as GBA (gameboy advance) or GBC (gameboy color) is limited to small LCD panel due to requirement of light weight and small volume. The players of such handheld games mainly are kids and children. The small display panel has poor resolution and dim and vague picture and lacks back light function. As a result, the vision of the kids and children are very likely to decline and the eyes of the kids and children may feel painful or even get hurt.

The game software of the existing games is able to provide solid audio and video effect and high resolution picture. Therefore, when playing the game, a player can have a live feeling and enjoy brilliant audio and video effect. However, the above handheld game with LCD panel can hardly achieve the live and brilliant effect.

### SUMMARY OF THE INVENTION

It is therefore a primary object of the present invention to provide a picture video signal converting/processing circuit for GBA (gameboy advance) or GBC (gameboy color). The circuit is able to convert the signals of the picture of the LCD panel of the GBA or GBC main frame into video signals acceptable and shown by all kinds of televisions and computer monitors. Therefore, a better revolution can be achieved and more brilliant picture is provided for the player to have more fun. Also, the player's eyes are protected from feeling painful or getting hurt.

The present invention can be best understood through the following description and accompanying drawings wherein:

### BRIEF DESCRIPTION OF THE DRAWINGS

FIG. 1 is a block diagram of the circuit of the present invention;

FIG. 2 is a complete block diagram of the main controlling circuit of the present invention; and

FIG. 3 is a block diagram of the flow chart of the present invention.

### DETAILED DESCRIPTION OF THE PREFERRED EMBODIMENTS

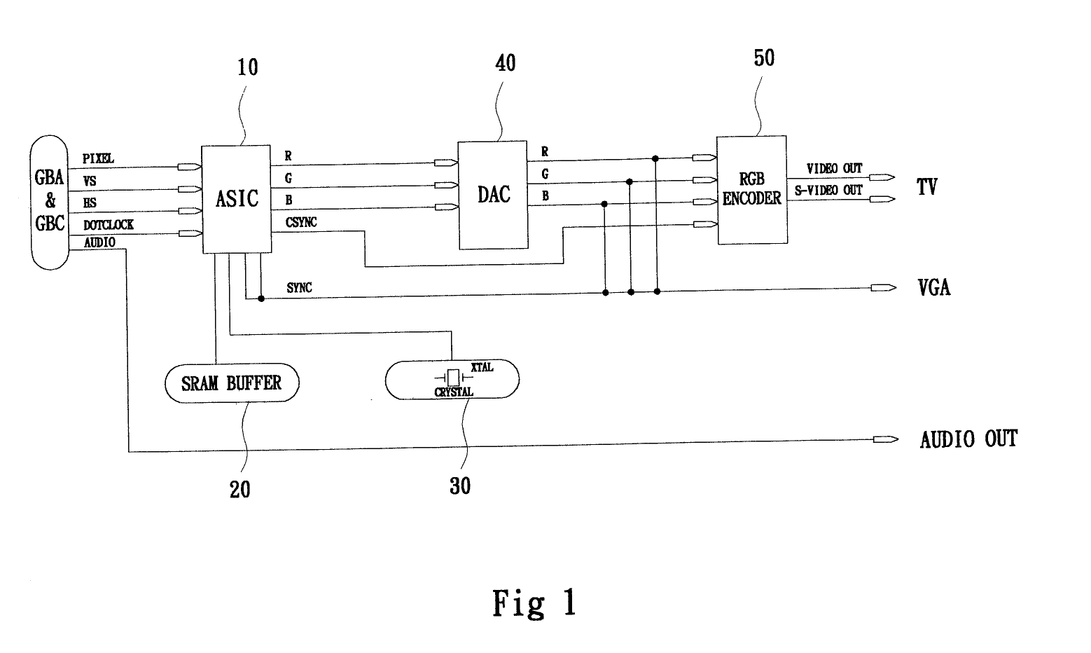

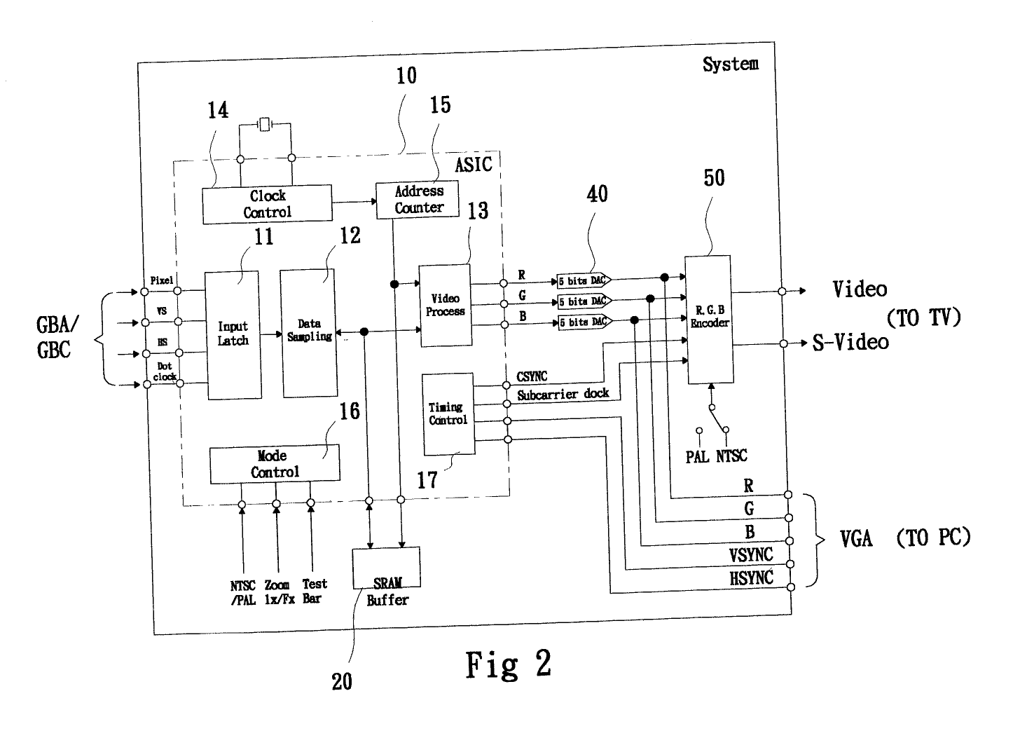

Please refer to FIGS. 1 and 2. The picture video signal converting/processing circuit for GBA (gameboy advance) or GBC (gameboy color) of the present invention includes a main controlling circuit (ASIC) 10, a memory buffer (SRAM BUFFER) 20, an oscillator (CRYSTAL) 30, a digital/analog signal converter (DAC) 40 and an RGB encoder 50.

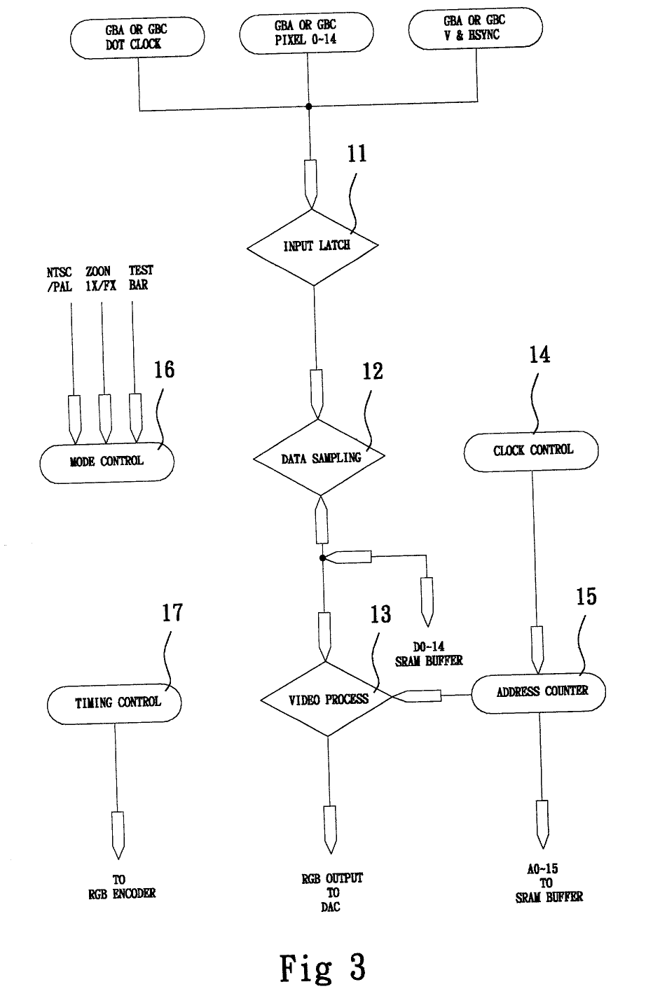

Referring to FIGS. 2 and 3, the main controlling circuit (ASIC) 10 is a programmable integrated circuit and has an input latch 11 for taking the video signal input produced by the GBA (gameboy advance) or GBC (gameboy color) game main frame or game cartridge, including pixel signal, horizontal synchronous signal (H-SYNC), vertical synchronous signal (V-SYNC), dot clock signal, audio signal, etc. The input latch 11 is further connected to a data sampling 12 which according to the taken RGB video signal generates a sampling time sequence used in the digital/analog signal converter (DAC) 40 for sampling. The data sampling is further connected to a video process 13 for combining the RGB signal into standard television signal and then outputting the signal. The main controlling circuit (ASIC) 10 is further equipped with a clock control 14 for effectively controlling the oscillating frequency of the output pulse signal of the crystal 30. The present invention further includes an address counter 15, a mode control 16 capable of distinguishing system signals of NTSC/PAL, ZOOM 1X/FX, TEST BAR, etc. and a timing control 17 for controlling output time sequency of pulse signal during a period of time. Accordingly, the present invention has the function of outputting chromatism synchronous signal to the RGB encoder 50.

The memory buffer (SRAM BUFFER) 20 mainly serves to store the RGB video signal in digital form.

The oscillator (CRYSTAL) 30 provides an always varying output pulse signal and keeps identifying and oscillating effect.

The digital/analog signal converter (DAC) 40 is able to convert the taken RGB video signal from digital form into analog form and send the signal to the RGB encoder 50.

The RGB encoder 50 serves to combine the received RGB video signal and chromatism synchronous signal into a combined signal for a television to receive. The signal is output via AV output terminal into television screen.

According to the above circuit, by means of a game cartridge adapter or disassembling the lower cover of the game main frame of the handheld GBA (gameboy advance) or GBC (gameboy color), the pixel signal, horizontal synchronous signal (H-SYNC), vertical synchronous signal (V-SYNC), dot clock signal and audio signal generated by the LCD panel are respectively taken and input. Through the command decoding of the main controlling circuit (ASIC) and in cooperation with the digital/analog signal converter (DAC), the signals are converted into RGB signals. At this time, the RGB encoder can convert and combine the above video signals into video signals acceptable by all kinds of televisions. The signals are then via AV output terminal or S output terminal input to the television. Accordingly, the picture of the LCD panel of the handheld GBA (gameboy advance) or GBC (gameboy color) can be converted and shown on the screens of various kinds of televisions. This enhances the fun of the players in playing the game. Moreover, the big screen provides more brilliant colorful picture and achieve live entertaining effect. Also, this prevents the player's eyes from feeling painful or getting hurt and avoids declination of vision of the player.

In addition, the video signals converted and combined by the RGB encoder is not only applicable to various specifications of television screens, but also can be processed by video graphic array interface card to convert and input the picture of the LCD panel of the handheld GBA (gameboy advance) or GBC (gameboy color) to various specifications of computer monitors.

The above embodiments are only used to illustrate the present invention, not intended to limit the scope thereof. Many modifications of the above embodiments can be made without departing from the spirit of the present invention.

What is claimed is:

1. Picture video signal converting/processing circuit for GBA or GBC, comprising:
a main controlling circuit (ASIC) which is a programmable integrated circuit and has an input latch for inputting video signal, the input latch being further connected to a data sampling which generates a sampling time sequence used in a digital/analog signal converter (DAC) for sampling, the data sampling being further connected to a video process, the main controlling circuit (ASIC) being further equipped with a clock control, an address counter, a mode control and a timing control connected to each other;
a memory buffer (SRAM BUFFER) mainly serving to store the RGB video signal in digital form;
an oscillator (CRYSTAL) providing an always varying output pulse signal and keeping identifying and oscillating effect;
a digital/analog signal converter (DAC) able to convert the taken RGB video signal from digital form into analog form and send the signal to a RGB encoder; and
an RGB encoder serving to combine the received RGB video signal and chromatism synchronous signal into a combined signal for a television to receive, the signal being output via AV output terminal into television screen, whereby through the command decoding of the main controlling circuit (ASIC) and in cooperation with the digital/analog signal converter (DAC), the input video signals are converted into RGB signals which are converted by the RGB encoder into video signals acceptable by all kinds of televisions, whereby the picture of the LCD panel of the handheld GBA or GBC can be converted and shown on the screens of various kinds of televisions.

2. Picture video signal converting/processing circuit for GBA or GBC as claimed in claim 1, wherein the video signals taken and input to the main controlling circuit includes pixel signal, horizontal synchronous signal (H-SYNC), vertical synchronous signal (V-SYNC), dot clock signal, audio signal, etc.

3. Picture video signal converting/processing circuit for GBA or GBC as claimed in claim 1, wherein by means of a game cartridge adapter or disassembling the lower cover of the game main frame of the handheld GBA or GBC, the converting/processing circuit is connected with the game main frame.

4. Picture video signal converting/processing circuit for GBA or GBC as claimed in claim 1, wherein the signals are via AV output terminal or S output terminal input to the television.

5. Picture video signal converting/processing circuit for GBA or GBC as claimed in claim 1, wherein the video signals converted by the RGB encoder can be processed by video graphic array interface card to convert and input the picture of the LCD panel of the handheld GBA or GBC to various specifications of computer monitors.
